(19) United States
(12) Patent Application Publication
(10) Pub. No.: US 2008/0241309 A1
(43) Pub. Date: Oct. 2, 2008

(54) Cam System For A Mold

(75) Inventors: Joachim Johannes NIEWELS, Thornton (CA); Jonah Irwin FINKELSTEIN, Toronto (CA); Michael Keith ZURAW, Georgetown (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton (CA)

(21) Appl. No.: 11/695,378

(22) Filed: Apr. 2, 2007

(51) Int. Cl. B29C 45/00; F16H 53/06

(52) U.S. Cl. 425/556; 74/569

(57) ABSTRACT

Disclosed herein is a flexible cam system for reducing the likelihood of damage and/or premature wear to components of a mold during use. The flexible cam system accommodates poor coordination between components of an injection molding system during movement of the components. The flexible cam system may include a cam and a cam follower. At least one of the cam and cam follower includes a support structure and an engagement member supported by the support structure. The engagement member defines an engagement surface and includes a compliance member that is operatively connected to at least a portion of the engagement surface to accommodate a force on the engagement surface by the other of the cam and cam follower.

### TECHNICAL FIELD

The present invention generally relates to molding machines, and more specifically the present invention relates to a cam system for use in controlling the relative movement of one or more mold elements of a molding machine.

### BACKGROUND OF THE INVENTION

Injection molding machines generally include a mold made up of first and second mold halves that together define a plurality of mold cavities. For certain types of articles, such as, for example, preforms for plastic drink bottles, each mold cavity is defined by a core on one mold half and an open cavity in the other mold half. Thus, one of the mold halves is a core plate which holds a plurality of cores, and one of the mold halves is a cavity plate, which contains open cavities into which the cores project. The cores define the interior walls of the of the preforms. The open cavities form most of the exterior wall of the preforms. A set of first and second mold split inserts is also provided for each core/cavity pair, and is used to form certain portions of the exterior of the preform, such as the threads and the support ledge. The mold split inserts are retained on a stripper plate that is itself associated with the core plate.

Once the preforms are molded and are sufficiently cool, the mold is opened to eject them. The opening of the mold takes place in two stages. In the first stage the core plate separates from the cavity plate along a machine axis. At the end of the first stage, the preforms are retained on the cores, and remain captured by the mold split inserts. In the second stage, the stripper plate moves relative to the core plate to remove the preforms from the cores, and the mold split inserts move laterally away from each other so that they no longer capture the preforms.

Typically, all of the first mold split inserts in a machine are connected together for movement in unison, and similarly, all of the second mold split inserts are also connected together for movement in unison. A pair of cam systems may be employed to control the movement apart of the first mold split inserts. The second mold split inserts may be moved by another pair of cam systems or by other means, such as by a mechanical linkage with the first mold split inserts.

Each cam system includes a cam and a cam follower. During operation of the injection molding machine, the first and second cam systems in each pair may be imperfectly coordinated with one another, due at least partially to the additive effect of the tolerances in the manufacture of the components of the machine. When imperfect coordination between the cam systems exists, the first cam system may urge the mold split inserts in a different direction or at a different rate than the second cam system. When this occurs, the cam systems work against each other thereby increasing the loads incurred by the cam system components. The increased loads can, over time, reduce the life of the cam system components. In some cases, the loads can lead to catastrophic failure of one or more of the components.

### SUMMARY OF THE INVENTION

The technical effect realized by at least some of the embodiments of the present invention and variations and alternatives thereof may include increased life of the components of cam systems and related mold components, and in particular cam systems that cooperate together for the movement of mold elements on a stripper plate.

In a first aspect of the present invention, a cam is provided, comprising a support structure and a cam follower engagement member supported by the support structure. The cam follower engagement member defines a cam follower engagement surface and includes a compliance member that is operatively connected to at least a portion of the cam follower engagement surface to accommodate a force on the cam follower engagement surface by a cam follower.

In a second aspect of the present invention, a cam follower is provided, comprising a support structure and a cam engagement member supported by the support structure. The cam engagement member defines a cam engagement surface and includes a compliance member that is operatively connected to at least a portion of the cam engagement surface to accommodate a force on the cam engagement surface by a cam.

In a third aspect of the present invention, a cam system is provided, comprising a cam and a cam follower. At least one of the cam and cam follower includes a support structure and an engagement member supported by the support structure. The engagement member defines an engagement surface and includes a compliance member that is operatively connected to at least a portion of the engagement surface to accommodate a force on the engagement surface by the other of the cam and cam follower.

In a fourth aspect of the present invention, a mold is provided, comprising a plurality of mold elements and a stripper assembly. The plurality of mold elements include a first mold half, a second mold half, a first mold split insert and a second mold split insert. The plurality of mold elements together define a mold cavity. The stripper assembly includes a stripper plate that is associated with one of the first and second mold halves for relative movement therewith, and further includes a cam and a cam follower. The cam and cam follower are configured to cooperate with each other to generate relative movement between at least one of the first and second mold split inserts and the stripper plate. At least one of the cam and cam follower includes a support structure and an engagement member supported by the support structure. The engagement member defines an engagement surface and includes a compliance member that is operatively connected to at least a portion of the engagement surface to accommodate a force on the engagement surface by the other of the cam and cam follower.

In a fifth aspect of the present invention, a molding system is provided, comprising a molding machine, a plurality of mold elements and a stripper assembly. The plurality of mold elements include a first mold half, a second mold half, a first mold split insert and a second mold split insert. The plurality of mold elements together define a mold cavity. The stripper assembly includes a stripper plate that is associated with one of the first and second mold halves for relative movement therewith, and further includes a cam and a cam follower. The cam and cam follower are configured to cooperate with each other to generate relative movement between at least one of the first and second mold split inserts and the stripper plate. At least one of the cam and cam follower includes a support structure and an engagement member supported by the support structure. The engagement member defines an engagement surface and includes a compliance member that is operatively connected to at least a portion of the engagement surface to accommodate a force on the engagement surface by the other of the cam and cam follower.

### BRIEF DESCRIPTION OF THE FIGURES

A better understanding of the exemplary embodiments of the present invention (including alternatives and/or variations thereof) may be obtained with reference to the detailed description of the exemplary embodiments along with the following drawings, in which:

FIG. 1a is a sectional view of an injection molding system, including a stripper assembly incorporating a cam system in accordance with an embodiment of the present invention, wherein the injection molding system is in a first position, wherein a plurality of mold elements are engaged with each other to define mold cavities;

FIG. 1b is a sectional view of the injection molding system shown in FIG. 1a, in a second position, wherein some mold elements are spaced apart and some mold elements are engaged with each other;

FIG. 1c is a sectional view of the injection molding system shown in FIG. 1a, in a third position, wherein all the mold elements are apart so that molded parts may be ejected;

FIG. 2a is a perspective view of the stripper assembly shown in FIG. 1a, with some portions shown as transparent for clarity;

FIG. 2b is an elevation view of the stripper assembly shown in FIG. 1a;

FIG. 3a is a sectional view of one of the cam systems shown in FIG. 2a;

FIG. 3b is a sectional view along section line 3b-3b of the cam system shown in FIG. 3a;

FIG. 4 is a perspective view of a cam from another one of the cam systems shown in FIG. 2a;

FIG. 5a is a perspective view of a cam system in accordance with another embodiment of the present invention;

FIG. 5b is a plan view of a cam follower shown in FIG. 5a;

FIG. 6 is a perspective view of a cam system in accordance with yet another embodiment of the present invention;

FIG. 7 is a perspective view of a cam system in accordance with yet another embodiment of the present invention;

FIGS. 8a, 8b and 8c are a plan view and two perspective views of a cam system in accordance with yet another embodiment of the present invention;

FIG. 9 is a perspective view of a cam in accordance with yet another embodiment of the present invention;

FIG. 10 is a perspective view of a cam in accordance with yet another embodiment of the present invention;

FIG. 11 is a perspective view of a cam in accordance with yet another embodiment of the present invention;

FIG. 12 is a perspective view of a cam system in accordance with yet another embodiment of the present invention;

FIG. 13 is a magnified plan view of a portion of a cam system in accordance with yet another embodiment of the present invention; and

FIG. 14 is a magnified plan view of a portion of a cam system in accordance with yet another embodiment of the present invention.

### DETAILED DESCRIPTION OF EMBODIMENTS

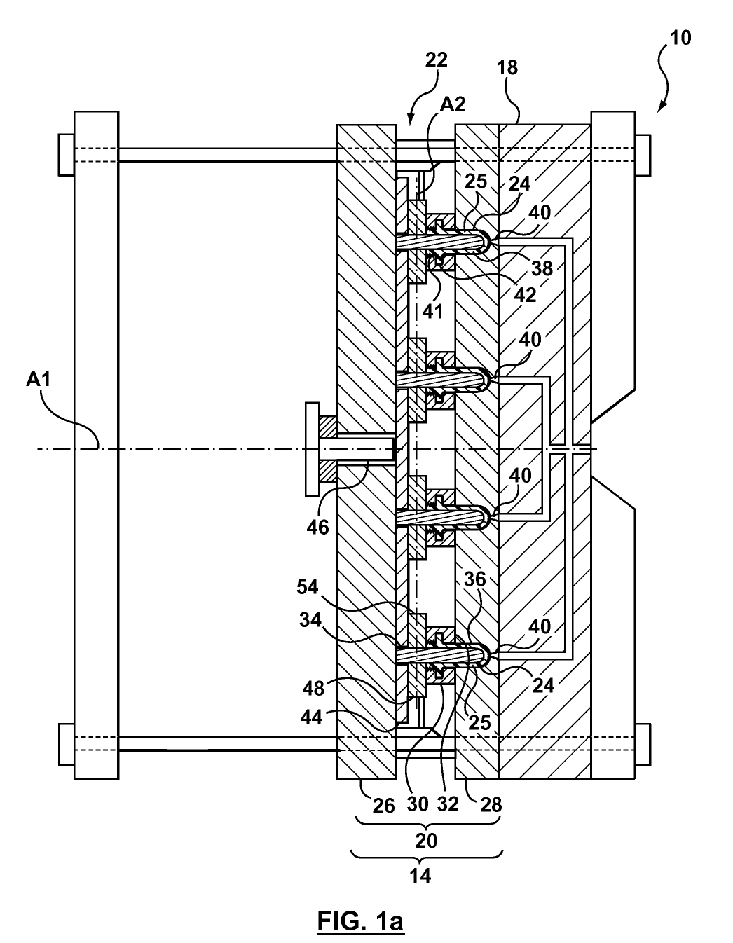

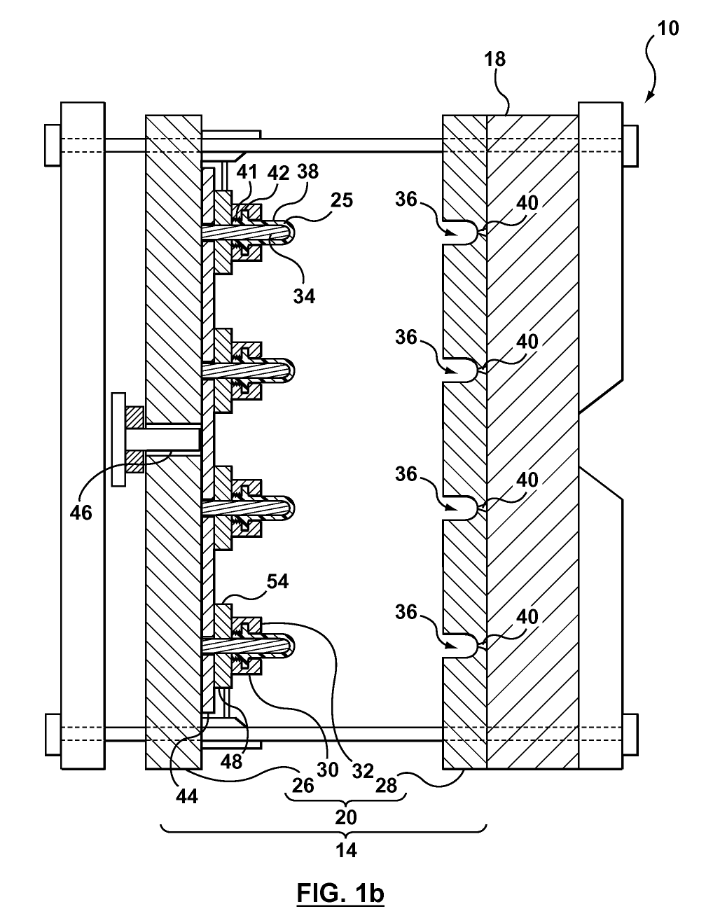

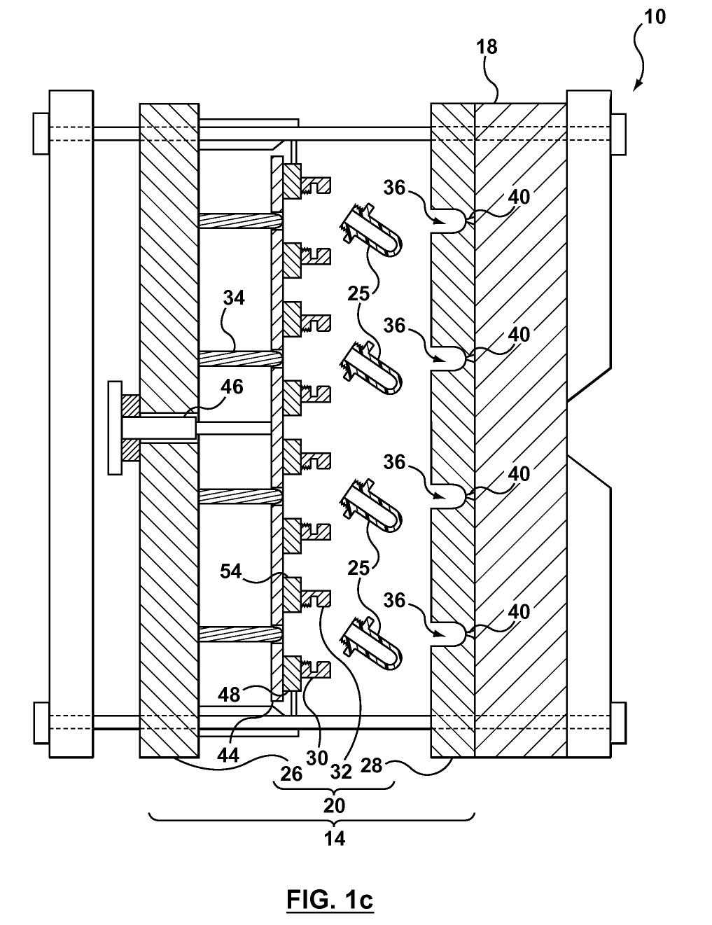

Reference is made to FIG. 1a, which shows an injection molding sub-system 10 in accordance with an embodiment of the present invention. The injection molding sub-system 10 includes a mold 14 and a runner system 18. One skilled in the art will appreciate that the mold 14 and the runner system 18 can form part of an injection molding machine (not depicted), which together with auxiliary injection molding equipment can form part of an injection molding system (not depicted).

The mold 14 includes a plurality of mold elements 20 and a stripper assembly 22. The mold elements 20 cooperate together to form a plurality of mold cavities 24 for producing molded articles 25, such as, for example, preforms, parisons and other types of injection molded pieces. One skilled in the art will appreciate that the number of mold cavities 24 may be any suitable number, such as, for example, 48, 96, 144, 216 mold cavities and the like. It is possible for the mold elements 20 to form as few as a single mold cavity. The mold elements 20 include a first mold half 26, a second mold half 28, a plurality of first mold split inserts 30 and a plurality of second mold split inserts 32.

The first and second mold halves 26 and 28 may be referred to by other names such as mold plates or mold elements. The term ‘mold half’ is not intended to denote that one half of a mold cavity 24 is defined by it. The term ‘mold half’ is not intended to convey that only two mold halves are involved in defining the one or more mold cavities 24. It is, for example, possible that more than two mold halves could be involved in defining the one or more mold cavities 24.

The mold halves 26 and 28 together define certain portions of the mold cavities 24. For example, the first mold half 26 may include a plurality of projections 34, which may be referred to as cores 34, which cooperate with a plurality of open cavities 36 in the second mold half 28 to form walls 38 of the molded articles 25. One skilled in the art will appreciate that other configurations for the first and second mold halves 26 and 28 are possible, for example, one may use molding inserts (not depicted) in the second mold half 28 to define the plurality of open cavities 36.

The first mold half 26 may be movable along a first axis A1, relative to the second mold half 28 so as to open and close the mold cavities 24, thereby permitting a repeating cycle of formation and ejection of molded articles 25.

The second mold half 28 is directly downstream from the runner system 18 and includes gates 40 into the mold cavities 24. The second mold half 28 may be stationary, or alternatively it may itself move relative to other plates in the injection molding system 10.

The first and second mold split inserts 30 and 32 move relative to each other along a second axis A2, which may be perpendicular to the first axis A1. The first and second mold split inserts 30 and 32 may cooperate to form features, such as threads 41 on the molded article 25, which are not easily formed by the mold halves 26 and 28. The first and second mold split inserts 30 and 32 may also cooperate to form other features, such as a support ledge 42 on the molded article 25. By forming a feature such as the support ledge 42, the first and second mold split inserts 30 and 32 capture the molded articles 25 and retain them in association with the first mold half 26 during separation of the first and second mold halves 26 and 28.

After articles 25 are molded in the mold cavities 24, removal of the molded articles 25 can be implemented as a two stage process. At the first stage, the molded articles 25 are removed from the open mold cavities 36 in the second mold half 28, and remain associated with the first mold half 26. More specifically the molded articles 25 remain associated with the cores 34 (by virtue of shrinkage of the molded articles 25) and with the first and second mold split inserts 30 and 32 (by virtue of being retained therebetween by means of the support ledge 42, for example). In other words, the movement of the first mold half 26 relative to the second mold half 28 along the axis A1 provides the first stage of the molded articles 25 removal. In the second stage, the molded articles 25 are removed from the first mold half 26. More specifically the stripper plate 44 is moved along the axis A1 which moves the molded articles 25 off the cores 34. Additionally the first and second mold split inserts 30 and 32 are moved relative to each other along the second axis A2 thereby releasing their capture of the support ledge 42 on the molded articles 25. At this point, the molded articles 25 are free from the mold cavities 24.

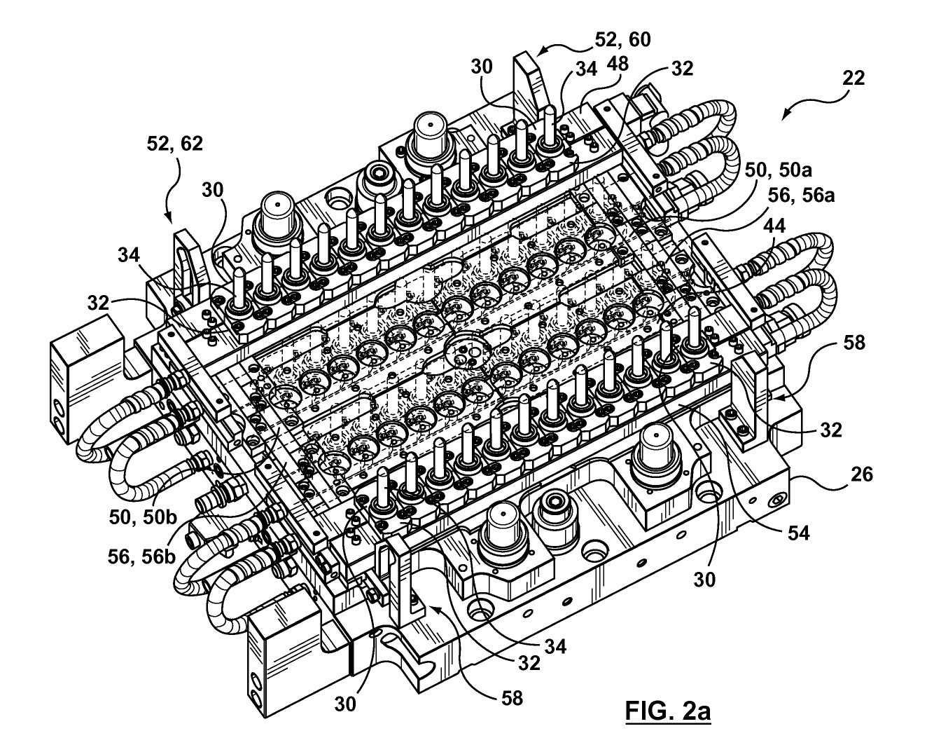

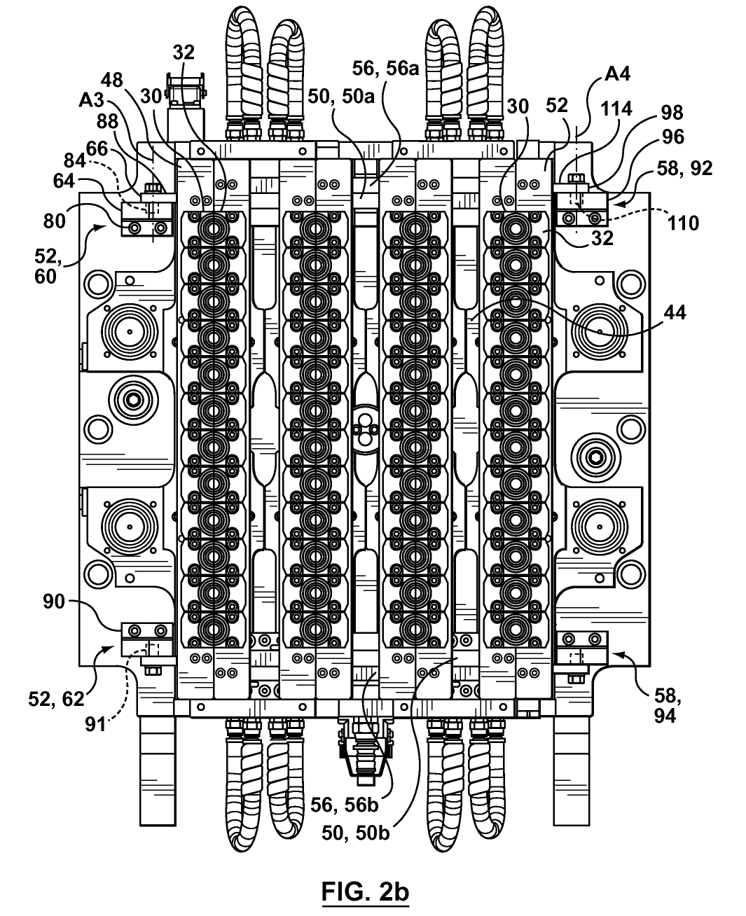

The stripper assembly 22 controls the first and second mold split inserts 30 and 32 and is used to remove the molded articles 25 from the cores 34. The stripper assembly 22 includes a stripper plate 44, a stripper plate driver 46, and, referring to FIG. 2a, a plurality of first mold split insert slide bars 48, a plurality of first mold split insert connecting bars 50, a plurality of first mold split insert cam systems 52, a plurality of second mold split insert slide bars 54, a plurality of second mold split insert connecting bars 56, and a plurality of second mold split insert cam systems 58. Some of the slide bars, mold split inserts and cores are shown in dashed outline only and are shown as transparent, so as to show the underlying structure and to simplify the drawing.

Referring to FIG. 1a, the stripper plate 44 may be associated with the first mold half 26. The stripper plate driver 46 moves the stripper plate 44 towards and away from the first mold half 26 during selected portions of a molding cycle along the axis A1. The stripper plate driver 46 may be any suitable drive means, such as a hydraulic ram.

Referring to FIG. 2a, the first mold split insert slide bars 48 are each oriented vertically. A plurality of first mold split inserts 30 are arranged in a vertical line on each slide bar 48. The slide bars 48 are connected together by the first mold split insert connecting bars 50. The connecting bars 50 are guided by the stripper plate 44, and are laterally movable, such as by sliding or rolling action, with respect to the stripper plate 44. In the embodiment shown in FIG. 2a, there is an upper connecting bar 50a and a lower connecting bar 50b. The slide bars 48 and connecting bars 50 connect all the first mold split inserts 30 for movement in unison relative to the stripper plate 44.

The first mold split insert cam systems 52 drive the movement of the first mold split inserts 30 towards and away from the second mold split inserts 32 along the axis A2, during movement of the stripper plate 44 towards and away from the first mold half 26 along the axis A1. The cam systems 52 may include one or more flexible first mold split insert cam systems 60, and may further include one or more non-flexible first mold split insert cam systems 62. In the embodiment shown in FIG. 2a, there is one flexible first mold split insert cam system 60 and one non-flexible first mold split insert cam system 62. However, one skilled in the art will appreciate that in an alternative non-limiting embodiment of the present invention, both of the first mold split insert cam systems 52 may be flexible first mold split insert cam systems 60 and, as such, the one or more non-flexible first mold split insert cam systems 62 can be omitted.

Referring to FIG. 2b, the cam system 60 includes a cam 64 and a cam follower 66, which are configured to cooperate to generate relative movement between the first mold split inserts 30 and the stripper plate 44 along the axis A2, and more particularly to generate movement of the first mold split inserts 30 towards and away from the second mold split inserts 32 along the axis A2.

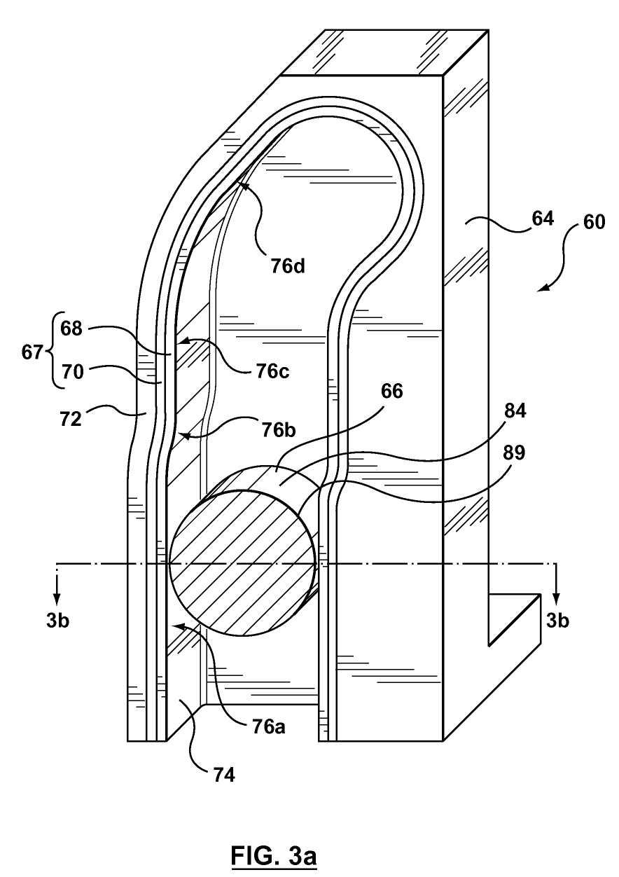

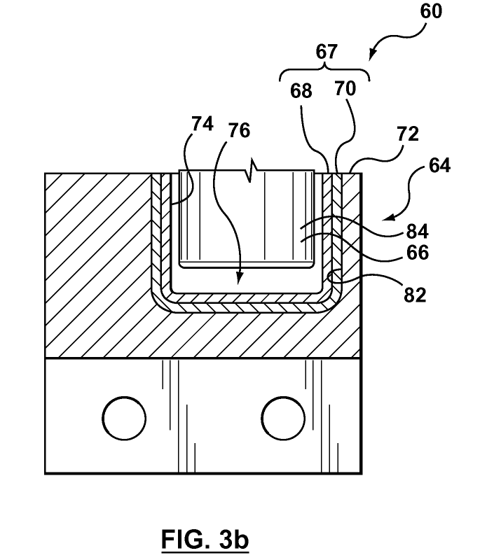

Referring to FIG. 3a, the cam 64 includes an engagement member 67 and a support structure 72. The engagement member 67, which may also be referred to as a cam follower engagement member 67, is configured to engage the cam follower 66 to drive the movement of the first mold split inserts 30. Referring to FIG. 3b, the engagement member 67 has an engagement surface 74 thereon, which may also be referred to as a cam follower engagement surface 74. The cam follower engagement surface 74 may have any suitable configuration. For example, the cam follower engagement member 67 may define a cam follower engagement channel 76 configured to receive the cam follower 66. The side walls of the engagement channel 76, therefore make up the cam follower engagement surface 74.

The engagement channel 76 has four portions 76a, 76b, 76c and 76d, shown in FIG. 3a. The first portion 76a extends generally linearly in a first direction. The second portion 76b is a relatively small dogleg, which causes the cam follower 66 to urge the first split insert 30 to open slightly. The third portion 76c extends generally linearly in the first direction again. The fourth portion 76d extends along a path away from the first direction. Along the fourth portion, the cam follower 66 urges the first mold split insert 30 to its full open position. One skilled in the art will appreciate that in alternative non-limiting embodiments of the present invention, the engagement channel 76 (FIG. 3b) may have more or fewer portions.

The engagement member 67 includes a flexible member 70 and a cover layer 68. The cover layer 68 has the engagement surface 74 thereon and is made from a suitably durable material, such as, for example, a suitable steel. The steel may be, for example, approximately 3 to approximately 5 mm thick.

The flexible member 70 is positioned between the support structure 72 and the cover layer 68 and is thus operatively connected to the engagement surface 74. The flexible member 70 permits some relative movement of the engagement surface 74 with respect to the support structure 72 and thus provide compliance to the engagement member 67. The flexible member 70 may thus be referred to as a compliance member. If the engagement member 67 and cam follower 66 are urged together during operation of the injection molding sub-system 10 (FIG. 1a), the engagement member 68 can absorb some of the energy during their urging together, as a result of the compliance provided by the compliance member 70. A technical effect can therefore be achieved in at least some embodiments of the present invention, whereby high peak loads may be effectively and substantially absorbed.

In the embodiment shown in FIG. 3a, the flexible member 70 is operatively connected to all of the engagement surface 74 and thus provides compliance to the entirety of the engagement surface 74. However in other embodiments it is alternatively possible for the flexible member to be operatively connected to only a segment of the engagement surface, as is described further herein.

The flexible member 70 may be a layer of flexible material in the support structure channel 82. The layer may be any suitable thickness, such as, for example, 3 to 5 mm. The flexible material may be any suitable material, such as, for example, polyurethane, or rubber. The flexible material could alternatively be some other polymeric material. As an alternative, the flexible member 70 may be made up of one or more discrete flexible elements, such as, for example, a plurality of metallic springs.

The flexible member 70 may be connected to both the support structure 72 and to the cover layer 68. For example, in the embodiment wherein the flexible member 70 is a layer of polymeric material, it may be connected to one or both of the support structure 72 and the cover layer 68 by a suitable adhesive. Alternatively, in embodiments wherein the flexible member 70 is a polymeric layer, it may be molded to one of the support structure 72 or the cover layer 68, and connected to the other of the support structure 72 and cover layer 68 by some other means, such as by an adhesive.

As another alternative, the flexible member 70 may be connected to only one of the support structure 72 and cover layer 68. For example, the flexible layer 70 may be molded to the support structure 72 and the cover layer 68 may simply rest on the flexible layer, without being connected to it. Suitable means for ensuring that the cover layer 68 remains in place during operation of the injection molding sub-system 10 (FIG. 1a) would be advantageous in such an embodiment.

The flexible member 70 may be resilient in the sense that it generally returns to an original rest shape upon removal of force from engagement with the cam follower 66. Thus, in embodiments wherein the flexible member 70 is resilient, it will compress to accommodate peak forces between the cam follower and cam, and it will urge the cover layer 68 back towards its rest position once the force between the cover layer 68 and cam follower 66 is reduced, removed or repositioned. It is alternatively possible, however, for the flexible member 70 to incur some plastic deformation when the cam follower 66 engages the cover layer 68. In such embodiments, the cover layer 68 may be urged to a new rest position that is different from its original rest position, after the force is reduced, removed or repositioned. Alternatively the cover layer 68 might not be urged anywhere after the force is changed, as a result of the plastic deformation.

The support structure 72 supports the engagement member 67. The support structure 72 itself connects to the first mold half 26 (FIG. 2b). The connection to the first mold half 26 may be by any suitable means, such as, for example, by a plurality of fasteners 80 or by a weld (not shown). Referring to FIG. 3b, the support structure 72 may include a support structure channel 82 for holding the engagement member 67.

The support structure 72 may be made from any suitable material, such as, for example, a suitable steel. The steel may be, for example, approximately 3 to approximately 5 mm thick in selected regions.

Referring to FIG. 2b and FIG. 3b, the cam follower 66 engages the cam 64. The cam follower 66 includes a roller 84 that is rotatable about a rotation axis A3, and a roller support structure 88 that supports the roller 84 and connects the roller 84 to the first mold split inserts 30.

Referring to FIG. 3a, the roller 84 has a cylindrical outer surface that is a cam engagement surface 89, and that engages the cam follower engagement surface 74 in the cam follower engagement channel 76 during operation. Referring to FIG. 2b, the roller 84 is rotatably mounted to the roller support structure 88 by any suitable means, such as by a bearing or by a bushing.

The roller support structure 88 may mount to one of the first mold split insert connecting bars 50, such as to the bar 50a, and therefore connects to all the first mold split inserts 30. The connection to one of the connecting bars 50 may be by any suitable means, such as, for example, by threaded fasteners. In an alternative non-limiting embodiment of the present invention, the roller support structure 88 may mount to one of the plurality of first mold split insert slide bars 48. In the embodiment shown in FIG. 2b, only the cam 64 is provided with a flexible member 70 (FIG. 3a); the cam follower 66 does not include a flexible member.

While a roller 84 is shown as the engagement member for the cam follower 66 shown in FIG. 2b, it is alternatively possible to have an engagement member that is not a roller. For example, the cam follower 66 could be provided with a fixed member at the end of the support structure 88 and the fixed member could slide along the cam follower engagement channel 76.

Referring to FIG. 2b, the non-flexible first mold split insert cam system 62 may have any suitable structure. For example, the cam system 62 may include a cam 90 and a cam follower 91. In the non-flexible first mold split insert cam system 62, there is no flexible member to accommodate any imperfect coordination between the cam system 62, the connecting bar 50 and the stripper plate driver 46. The cam 90 may be connected to the first mold half 26 in similar manner to the connection between the support structure 72 and the first mold half 26.

The second mold split insert slide bars 54 may be similar to the first mold split insert slide bars 48, but may be mirror images of them. A plurality of second mold split inserts 32 are arranged in a vertical line on each slide bar 54. The slide bars 54 are connected together by the second mold split insert connecting bars 56. The connecting bars 56 are guided by the stripper plate 44, and are laterally movable, such as by sliding or rolling action, with respect to the stripper plate 44. In the embodiment shown in FIG. 2a, there is an upper connecting bar 56a and a lower connecting bar 56b. The slide bars 54 and connecting bars 56 connect all the second mold split inserts 32 for movement in unison relative to the stripper plate 44.

The second mold split insert cam systems 58 drive the movement of the second mold split inserts 32 towards and away from the first mold split inserts 30 along the axis A2, during movement of the stripper plate 44 towards and away from the first mold half 26 along the axis A1. The cam systems 58 may include one or more flexible second mold split insert cam systems 92, and may further include one or more non-flexible first mold split insert cam systems 94. In the embodiment shown in FIG. 2a, there is one flexible second mold split insert cam system 92 and one non-flexible second mold split insert cam system 94. However, one skilled in the art will appreciate that in an alternative non-limiting embodiment of the present invention, both of the second mold split insert cam systems 58 may be flexible second mold split inserts cam systems 92 and, as such, the one or more non-flexible second mold split insert cam systems 94 can be omitted.

The flexible second mold split insert cam system 92 may be similar to the flexible first mold split insert cam system 62, and may include a cam 96 and a cam follower 98, which are configured to cooperate to generate relative movement between the second mold split inserts 32 and the stripper plate 44 along the axis A2, and more particularly to generate movement of the second mold split inserts 32 towards and away from the first mold split inserts 30 along the axis A2.

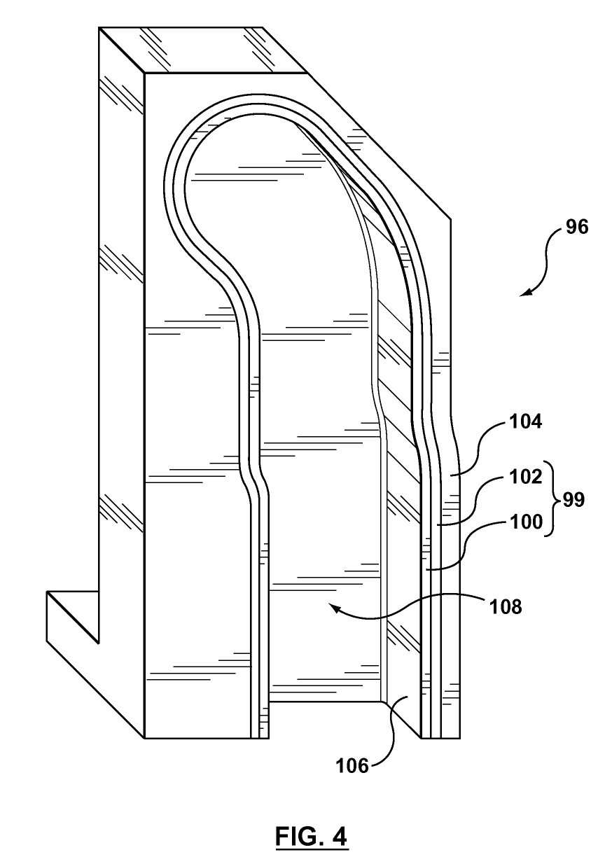

Referring to FIG. 4, the cam 96 may be similar to the cam 64 but may be a mirror image thereof, so as to drive the second mold split inserts 32 in the opposite direction from the direction of travel of the first mold split inserts 30 during operation of the injection molding sub-system 10 (FIG. 1a). Thus, the cam 96 may include an engagement member 99 and a support structure 104. The engagement member 99 itself includes a flexible member 102 and a cover layer 100, which may be similar to the flexible member 70 and the cover layer 68 shown in FIG. 3a, but which may be a mirror configuration thereof. Similarly the support structure 104 may be a mirror configuration of the support structure 72 shown in FIG. 3a. The flexible member 102 provides compliance to the engagement member 99 and may thus be referred to as a compliance member. The cam follower engagement surface on the engagement member 100 is shown at 106, in an engagement member channel 108.

Referring to FIG. 2a, the cam follower 98 engages the cam 96 and may be similar to the cam follower 64, and may include an engagement member 110, which is a roller that is rotatable about a rotation axis A4, and a support structure 114 that supports the engagement member 110 and connects the engagement member 110 to the second mold split inserts 32.

The support structure 114 may mount to one of the second mold split insert connecting bars 56, such as to the bar 56a, and therefore connects to the entire second mold split inserts 32. The connection to one of the connecting bars 56 may be by any suitable means, such as, for example, by threaded fasteners. In an alternative non-limiting embodiment of the present invention, the support structure 114 may mount to one of the plurality of second mold split insert slide bars 54.

The non-flexible second mold split insert cam system 94 may be a mirror image to the non-flexible first mold split insert cam system 62, but may be otherwise similar to the cam system 62.

Referring to FIG. 1a, in operation, the injection molding sub-system 10 undergoes a molding cycle which is described below. In the position shown in FIG. 1a, the mold elements 26, 30, 32 and 28 are in a closed position, so that they together define the mold cavities 24. Molding material is injected into the cavities 24 to form molded articles 25. Once sufficient hardening of the molding material has taken place in the cavities 24, the first mold half 26, the stripper assembly 22, and the first and second mold split inserts 30 are all moved away from the second mold half 28, to a position shown FIG. 1b. At this stage, the molded articles 25 are removed from the open cavities 36 in the second mold half 28 and remain associated with the first mold half 26 and the first and second mold split inserts 30 and 32. This may be at least in part because the molded articles 25 are captured by the first and second mold split inserts 30 and 32. For example, in embodiments where the molded articles 25 are beverage container preforms, each set of a first mold split insert 30 and a second mold split insert 32 may capture the threaded portion 41 and the support ledge 42 on one of the preforms.

When the first mold half 26, the stripper assembly 22, and the first and second mold split inserts 30 are sufficiently spaced from the second mold half 28, and when the molding material has hardened sufficiently, the stripper plate 44 is moved by the stripper plate driver 46 away from the first mold half 26, as shown in FIG. 1c. During this motion, the cam systems 60 and 62, and 92 and 94 (FIG. 2a) urge the first and second mold split inserts 30 and 32 apart sufficiently so that they no longer capture the molded articles 25 (FIG. 1c). The molded articles 25 can then be removed from the cores 34 by any suitable means. During the movement of the stripper plate 44, if there is poor coordination between the cam system 60 (FIG. 2b), the cam system 62 and the stripper plate driver 46 (FIG. 1a), the presence of the flexible member 70 (FIG. 3a) permits the cover layer 68 to flex so as to inhibit damage to the cam systems 60 and 62 (FIG. 2b), and to other components of the injection molding sub-system 10 (FIG. 1a). Similarly, if there is poor coordination between the cover layer 100, the cam system 94 and the stripper plate driver 46 (FIG. 1a), the presence of the flexible member 102 (FIG. 4) permits the cam 92 to flex so as to inhibit damage to the cam systems 92 and 94 (FIG. 2a), and to other components of the injection molding sub-system 10 (FIG. 1a), for example, the first and second mold split insert slide bars 48, 54.

Once the molded articles 25 are removed from the cores 34, the stripper plate driver 46 moves the stripper plate 44 back towards the position shown in FIG. 1b. During this motion, the cam systems 60 and 62, and 92 and 94 (FIG. 2b) urge the first and second mold split inserts 30 and 32 together. After, or during, the aforementioned movement of the stripper plate 44, the movable first mold plate 26 is moved back to the position shown in FIG. 1a to close the mold cavities 24, so that another shot of molding material can be injected into the mold cavities 24.

With respect to the embodiment shown in FIG. 2a, it has been described that one or more first mold split insert cam systems 52 move the first mold split inserts 30 laterally and one or more second mold split insert cam systems 58 move the second mold split inserts 32 laterally. It is alternatively possible for the second mold split inserts 32 to be operatively driven by the movement of the first mold split inserts 30. For example, a gear mechanism similar to that which is illustrated and described in U.S. Pat. No. 6,799,962, which is hereby incorporated by reference, may be positioned between the first mold split insert connecting bars 50 and the second mold split insert connecting bars. In this alternative, one or more cam systems 52, at least one of which is a flexible cam system 60, would be used to control the movement of the first mold split inserts 30. As the first mold split inserts 30 are urged away from the molded article 25 (FIG. 1c) and away from the second mold split inserts 32, the gear mechanism drives the second mold split inserts 32 in the opposite direction, ie. away from the molded articles 25 and away from the first mold split inserts 30. Similarly, as the first mold split inserts 30 are urged towards the second mold split inserts 32, ie. towards a closed position, the gear mechanism urges the second mold split inserts 32 towards the first mold split inserts 30.

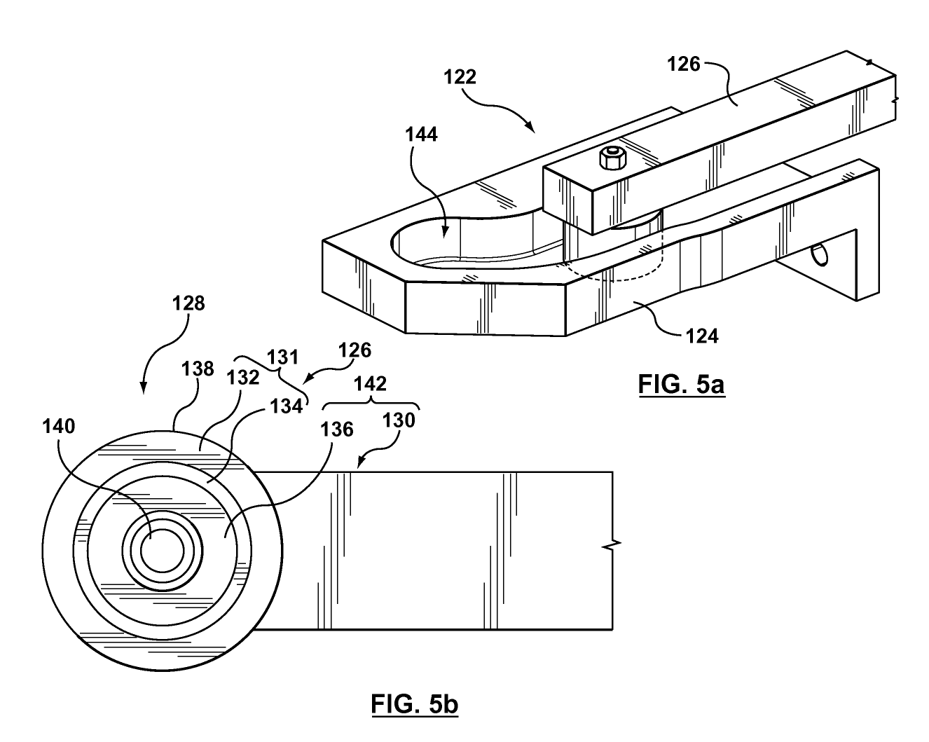

It has been shown in FIG. 3a for the flexible cam system 60 to include a flexible cam 64. Reference is made to FIG. 5a, which shows a cam system 122 in accordance with another embodiment of the present invention, and which can be used as part of the injection molding sub-system 10 shown in FIG. 2a. The cam system 122 includes a cam 124 and a flexible cam follower 126. The cam 124 may lack a flexible member and may thus be similar to the cam 90 shown in FIG. 2b.

Referring to FIG. 5b, the cam follower 126 includes a roller 128 and a roller support structure 130. The roller 128 includes a core 136 and an engagement member 131, which itself is made up of a flexible member 134 and a cover layer 132. The cover layer 132 may have any suitable shape, such as a generally tubular shape. The cylindrical outer surface of the cover layer 132 is the engagement surface 138 which engages the cam 124 (FIG. 5a). The flexible member 134 may also have a generally tubular shape, which fits within the tubular shape of the cover layer 132. The flexible member 134 itself is positioned around the core 136. The flexible member 134 is operatively connected to the engagement surface 138 through the cover layer 132 and thereby provides compliance to the engagement member 131 and may thus be referred to as a compliance member. In the embodiment shown in FIG. 5b, the flexible member 134 is operatively connected to the entirety of the engagement surface 138. However it is alternatively possible for the flexible member to be operatively connected to only a segment of the engagement surface in other embodiments, as is described further herein.

The roller 128 may be rotatably mounted to the roller support structure 130 by any suitable means. For example, the roller 128 may be connected to a shaft 140 that is part of the roller support structure, by a bearing or bushing or the like. The roller support structure 130 and the core 136 together make up an engagement member support structure 142.

During movement of the stripper plate 44 (FIG. 1a) relative to the first mold half 26, the roller 128 (FIG. 5b) rolls along the channel, shown at 144 in FIG. 5a, of the cam 124. If there is poor coordination between the cam system 122 (FIG. 5a), the cam system 62 (FIG. 2b), and the stripper plate driver 46 (FIG. 1a), the presence of the flexible member 134 (FIG. 5b) permits the engagement surface 138 to move so as to inhibit excessive wear and damage to the cam systems 62 (FIG. 2a) and 122 (FIG. 5a), and to other components of the injection molding sub-system 10 (FIG. 1a).

The material of the flexible member 134 may be any suitable material, such as, for example, any of the materials optionally usable for the flexible member 70 (FIG. 3b).

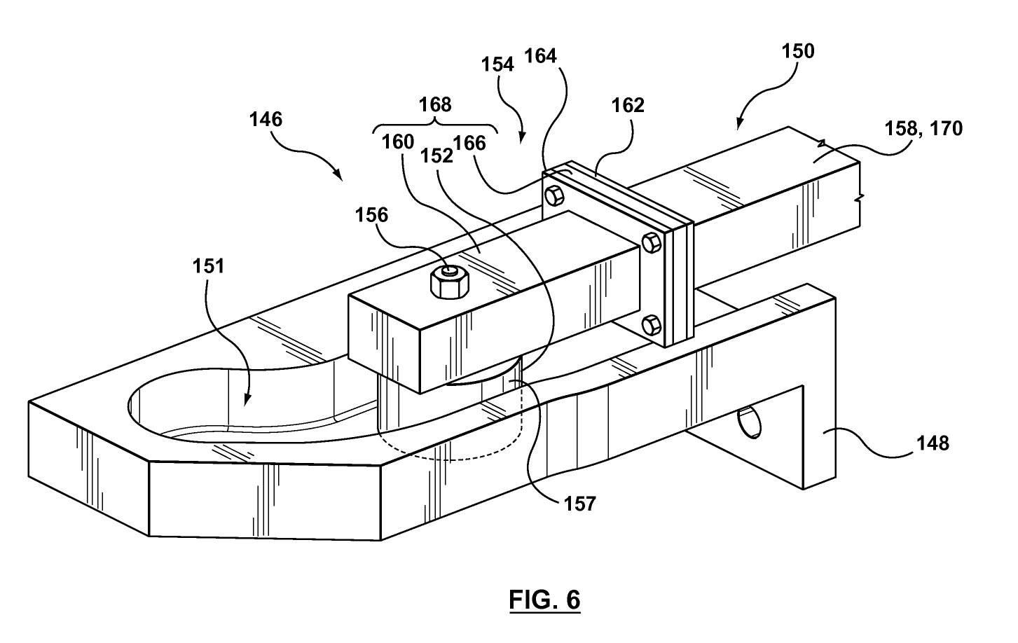

Reference is made to FIG. 6, which shows a cam system 146 in accordance with another embodiment of the present invention, and which can be used as part of the injection molding sub-system 10 shown in FIG. 1a. The cam system 146 includes a cam 148 and a cam follower 150. The cam 148 may be similar to the cam 124 shown in FIG. 5a, and may have a channel 151. The cam follower 150 includes a roller 152 and a roller support structure 154. The roller 152 is rotatably connected to the roller support structure 154 by any suitable means, such as by means of a rotatable connection to a shaft 156 that may be part of the roller support structure 154. The circumferential surface of the roller 152 is shown at 157 and is a cam engagement surface.

The roller support structure 154 includes a first portion 158 and a second portion 160, which are connected together by any suitable means. For example, flanges 162 and 164 may be provided at the adjoining ends of the first and second portions 158 and 160, and suitable fasteners may pass through apertures in the flanges 162 and 164. The first portion 158 is connected to one of the connecting bars 50. The second portion 160 has the roller 152 connected thereto for rotation. A flexible member 166 is sandwiched by the flanges 162 and 164 is thus positioned between the first and second portions 158 and 160, permitting the second portion 160 to move relative to the first portion 158.

The flexible member 166, the second portion 160 and the roller 152 together make up an engagement member 168. The flexible member 166 is operatively connected to the engagement surface 157 and permits the engagement surface 157 (and the entire roller 152 and the second portion 160) to move to accommodate a force during engagement between the engagement surface 157 and the cam 124. In the embodiment shown in FIG. 6, the flexible member 166 provides compliance to the entirety of the engagement surface 157 and thus may be said to be operatively connected to the entirety of the engagement surface 157. The flexible member 166 may be referred to as a compliance member.

The first portion 158 makes up an engagement member support structure 170 for supporting the engagement member 168 and for connecting the engagement member 168 to the first mold split inserts 30 (FIG. 2b) through the connecting bars 50 and the slide bars 48.

During movement of the stripper plate 44 (FIG. 1a) relative to the first mold half 26, the roller 152 (FIG. 6) rolls along the channel 151 in the cam 148. If there is poor coordination between the cam system 62 (FIG. 2b), the cam system 146 (FIG. 6) and the stripper plate driver 46 (FIG. 1a), the presence of the flexible member 166 provides compliance to the cam engagement member 168 to accommodate loads incurred between the engagement member 168 and the cam 148, thereby inhibiting excessive wear and damage to the cam systems 62 (FIG. 2b) and 146 (FIG. 6), and to other components of the injection molding sub-system 10 (FIG. 2b).

The material of the flexible member 166 may be any suitable material, such as, for example, any of the materials optionally usable for the flexible member 70 (FIG. 3b).

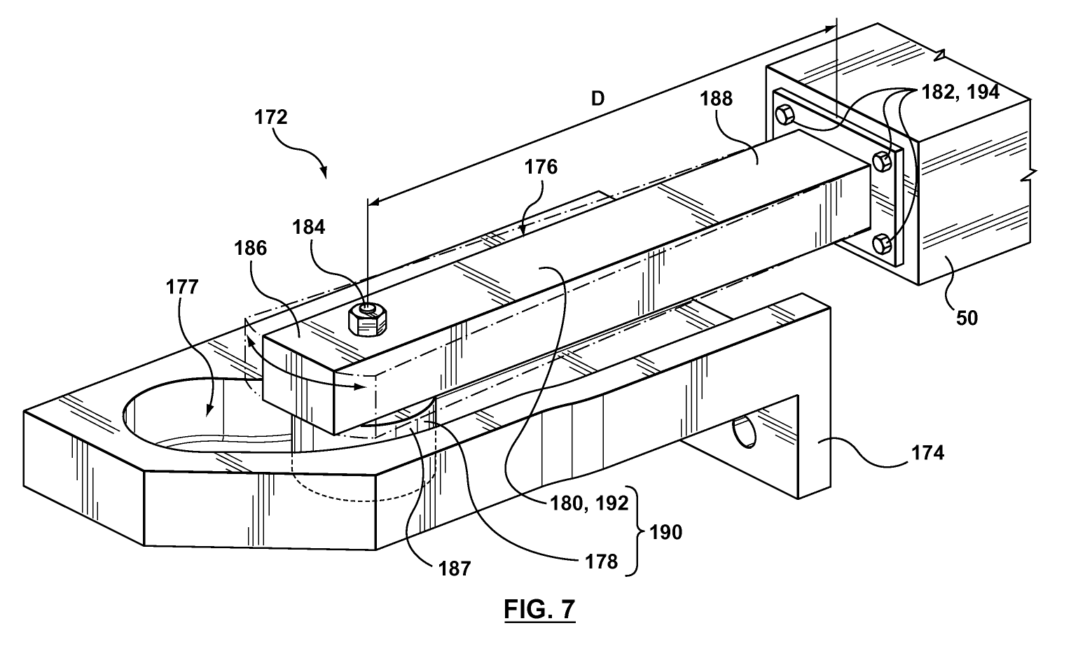

Reference is made to FIG. 7, which shows a cam system 172 in accordance with another embodiment of the present invention. The cam system 172 includes a cam 174 and a cam follower 176. The cam 174 may be similar to the cam 124 shown in FIG. 5a, and may have a channel 177. The cam follower 176 includes a roller 178, a roller support structure 180 and a connector 182. The roller 178 is rotatably connected to the roller support structure 180 by any suitable means, such as, by a rotatable connection to a shaft 184 at a first end 186 of the roller support structure 180. The circumferential surface of the roller 178 is an engagement surface and is shown at 187.

The roller support structure 180 has a second end 188 which is connected to one of the connecting bars 50 by the connector 182. The connector 182 may be any suitable type of connector. For example, the connector may be one or more threaded fasteners. Alternatively, the connector may be one or more welds.

The roller support structure 180 itself is made sufficiently flexible that it deflects to accommodate poor coordination between the cam system 62 (FIG. 2a), the cam system 172 (FIG. 7) and the stripper plate driver 46 (FIG. 1a), thereby inhibiting damage and/or premature wear to the cam systems 62 (FIG. 2a) and 172 (FIG. 7) and to other components of the injection molding sub-system 10 (FIG. 2a). Thus, the roller support structure 180 may be referred to as a flexible member 192 or a compliance member 192, and the roller 178 and the flexible member 192 may together be referred to as an engagement member 190. The flexible member 192 is operatively connected to the engagement surface 187 through the roller 178 and thereby provides compliance to the engagement surface 187 to accommodate loads incurred between the engagement surface 187 and the cam 174. The connector 182 may be referred to as the engagement member support structure 194. The flexible member 192 is operatively connected to the entirety of the engagement surface 187. However, embodiments are contemplated wherein the flexible member is operatively connected to only a segment of the engagement surface.

The distance between the position at which the roller support structure 180 connects to the roller 178 and the position at which the roller support structure 180 connects to the connecting bar 50 is shown as distance D.

There are several factors which impact the degree of flexibility of the roller support structure 180, including but not limited to the material of manufacture of the roller support structure 180, the cross-sectional area of the connection member 180 in the appropriate plane relative to the bending forces on it, and the distance D. All of these factors can be selected to provide the selected degree of deflection based on the forces that the connection member 180 may incur during operation of the injection molding sub-system 10 (FIG. 1a). The material of manufacture of the roller support structure 180 may be any suitable material, such as a suitable steel or other suitable metal.

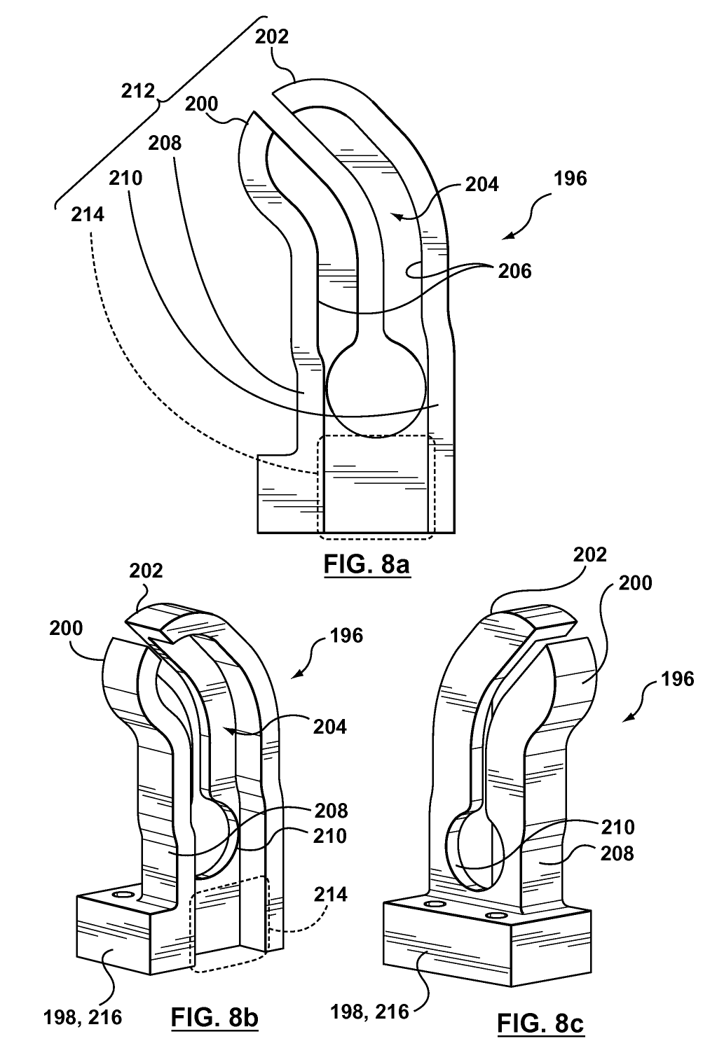

Reference is made to FIGS. 8a, 8b and 8c, which show a cam 196 that could be used in place of the cam 64 in the stripper assembly shown in FIG. 2b. The cam 196 includes a base 198 (FIGS. 8b and 8c) for attachment to the first mold half 26 (FIG. 2b), and two arms 200 and 202 which extend outwards from the base 198. A channel 204 (FIGS. 8a and 8b) is defined in part by the two arms 200 and 202. The walls of the channel 204 make up a cam follower engagement surface 206 (FIG. 8a).

The two arms 200 and 202 each end at relatively flexible portions, shown at 208 and 210 respectively, which may be referred to as flexible members 208 and 210. A cam follower engagement member 212 (FIG. 8a) includes the arms 200 and 202, the flexible members 208 and 210 and the portion of the cam 196 that defines a non-movable portion of the channel walls, shown at 214.

By virtue of their connection to the arms 200 and 202, the flexible members 208 and 210 are operatively connected to a portion of the engagement surface 206 and permit the portion of the surface 206 on the arms 200 and 202 to move during engagement with a cam follower, such as the cam follower 66 (FIG. 2b). Thus the flexible members 208 and 210 provide compliance to a portion of the engagement surface 206 to accommodate poor coordination with the cam system 62 (FIG. 2b) and the stripper plate driver 46 (FIG. 1a), so as to inhibit damage to the cam systems and to other components of the injection molding sub-system 10 (FIG. 1a). Thus, the flexible members 208 and 210 may be referred to as compliance members. The base 198 (FIGS. 8b and 8c) makes up a support structure 216.

The cam 196 may be made from any suitable material such as a suitable steel or other suitable metal. One skilled in the art will appreciate that the flexibility of the flexible members 208 and 210 may be varied, for example, by varying the shape and/or dimension of at least one of the flexible members 208 and 210. As such, the flexibility of one or more of the flexible members 208 and 210 can be controlled as may be desired for a particular application. Furthermore, it should be appreciated that flexible member 208 and the flexible member 210 need not necessarily be of the same configuration and, in alternative non-limiting embodiments, may be configured differently from each other.

It will be noted that, in the embodiment shown in FIGS. 8a, 8b and 8c, the flexible members 208 and 210 define a portion of the cam follower engagement surface 206.

In the embodiment shown in FIG. 1a, each mold cavity 24 is defined by four mold elements 20, namely the movable first mold plate 26, the second mold plate 28, one of the movable first mold split inserts 30 and one of the movable second mold split inserts 32. It is alternatively possible for each mold cavity to be defined by more or fewer mold elements. For example, the injection molding sub-system 10 may have a movable first mold half, a second mold half, and a plurality of movable first mold split inserts that mate with some portion of the first mold half to capture a feature on the molded article. In such an embodiment, movement of the first mold split inserts away from the first mold half would be sufficient to permit the molded part to be ejected from the first mold half.

It has been shown in FIG. 2b for the injection molding sub-system 10 (FIG. 1a) to include two cam systems 52 to control the opening and closing of the first mold split inserts 30. It is alternatively possible for the injection molding sub-system 10 to include more or fewer cam systems for controlling the opening and closing of the first mold split inserts 30. For example, a single cam system could be used, which would be flexible and could have any of the flexible configurations described and/or shown in the Figures, so as to permit deflection of at least one of the cam and cam follower to accommodate poor coordination between the cam system and the stripper plate driver 46 (FIG. 1a), thereby inhibiting damage and/or premature wear to the cam system. In embodiments wherein a plurality of cam systems are used, they may all have flexible members incorporated therein. Alternatively, some, or as few as one, could have the flexible member incorporated therein.

In each mating set of first and second mold split inserts 30 and 32 (FIG. 2b), the first mold split inserts 30 have been shown as the left ones in the figures and the second mold split inserts 32 have been shown as the right ones. It is alternatively possible for the first mold split inserts 30 to be the ones on the right and for the second mold split inserts 32 to be those on the left.

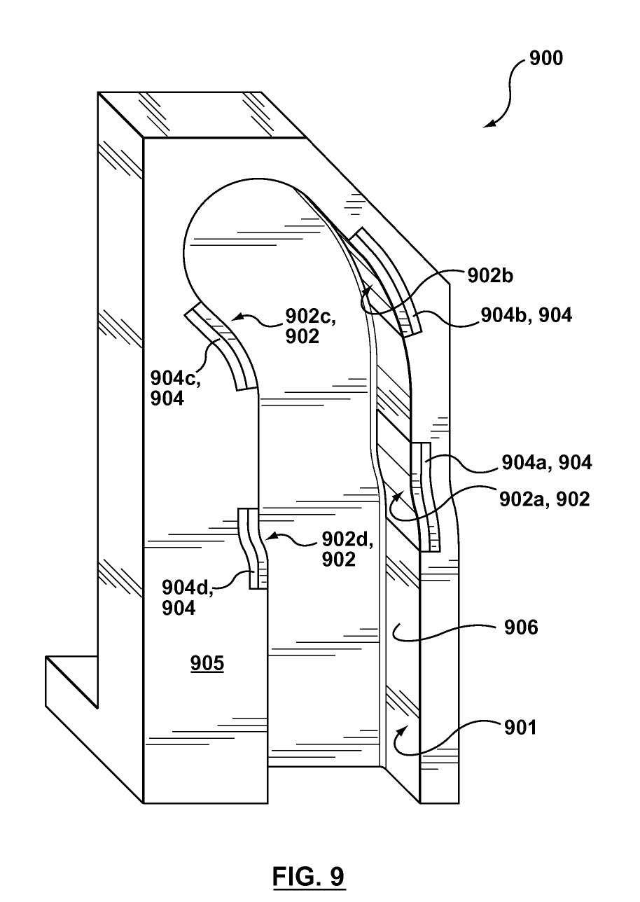

FIG. 9 depicts another non-limiting embodiment of the present invention. In the embodiment of FIG. 9, a cam 900 includes a cam follower engagement member 901 and a support structure 905 which supports the cam follower engagement member 901. The cam follower engagement member 901 defines a cam follower engagement surface 906.

The cam follower engagement member 901 includes a plurality of flexible members 904, which are individually identified at 904a, 904b, 904c and 904d, and which are covered by cover layers 902, which are individually identified at 902a, 902b, 902c and 902d respectively. The cover layers 902 each define a portion of the cam follower engagement surface 906.

The flexible member 904a, 904b, 904c and 904d may be positioned at selected positions in the cam engagement member 901 so that they are operatively connected to portions of the cam engagement surface 906 where its path changes direction. These regions of direction change and which can be subject to high peak loads during engagement with a cam follower. Each of the flexible members 904 may be referred to as a compliance member.

In the embodiment shown in FIG. 9, the engagement member 901 includes a plurality of compliance members, each of which provides compliance to a portion of the engagement member 901.

Each of the flexible members 904a, 904b, 904c and 904d can have a selected degree of flexibility, such that the flexibility of the different regions of the engagement member 901 can have different flexibilities.

Any or all of the flexible members 904 may be resilient in the sense that they generally return to an original rest shape upon removal of force from engagement with the cam follower. Thus, any flexible member 904 that is resilient will compress to accommodate peak forces between the cam follower and cam, and it will urge its associated cover layer 902 back towards its rest position once the force between that cover layer 902 and cam follower is reduced or removed. It is alternatively possible, however, for the flexible member 904 to incur some plastic deformation when the cam follower engages the cover layer 902. In such embodiments, the cover layer 902 may be urged to a new rest position that is different from its original rest position, after the force is reduced or removed. Alternatively the cover layer 902 might not be urged anywhere after the force is changed, as a result of the plastic deformation.

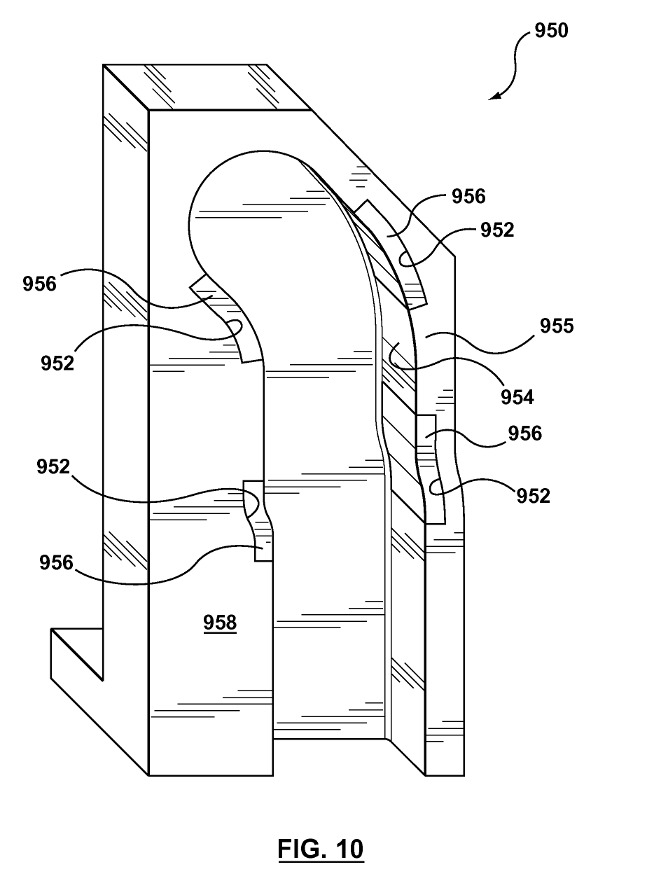

Referring to FIG. 10, in yet another embodiment of the present invention, a cam 950 is provided that includes slots 952 machined into a cam engagement surface 954 that is part of a cam follower engagement member 955. The plurality of slots 952 are filled with flexible members 956 formed from a flexible material (for example, polyurethane or rubber). The flexible members 956 thus define portions of the cam follower engagement surface 954. In this way, the flexible members 956 are operatively connected to the engagement surface 954 and provide compliance to portions thereof.

Any or all of the flexible members 956 may be resilient, or may alternatively incur some plastic deformation during engagement with the cam follower. The support structure is shown at 958.

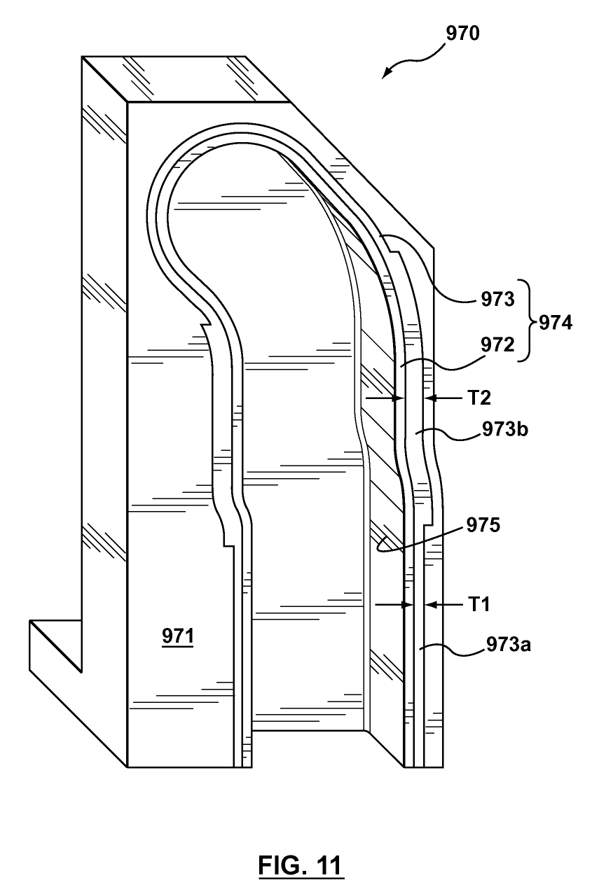

Referring to FIG. 11, a cam 970 is provided in an alternative non-limiting embodiment of the present invention. The cam 970 may be operable with any suitable cam follower, such as the cam follower 66 shown in FIG. 2b. The cam 970 includes a support structure 971, which may be similar to the support structure 72 of FIG. 3a, and a cam follower engagement member 974 which includes a flexible member 973 or compliance member 973, and a cover layer 972, which defines a cam follower engagement surface 975. The flexible member 973 and the cover layer 972 may be substantially similar to the a flexible member 70 and the cover layer 68 of FIG. 3a. The flexible member 973 is operatively connected to the engagement surface 975 through the cover layer 972 and thereby provide compliance to the engagement surface 975 to accommodate forces between the engagement surface 975 and a cam follower such as cam follower 66 (FIG. 3a).

Optionally, the flexible member 973 may include a first region 973a having a first thickness T1 of flexible material and a second region 973b having a second thickness T2 of flexible material, wherein, for example, the second thickness T2 is greater than the first thickness T1. The one or more second regions 973b may be disposed at specific regions of the flexible member 973 that, for example, can be subject to high peak loads, or which may be regions where the potential degree of misalignment between the cam 970 and cam follower 66 (FIG. 2b) is relatively higher. The thicknesses T1 and T2 of the regions 973a and 973b provide selected degrees of flexibility of those regions 973a and 973b. For example, a region having a relatively thicker layer of flexible material may have a greater flexibility than a region having a relative thinner layer of flexible material. In this way, the flexibility of the flexible member 973 can be selected regionally. Preferably, the wall thickness of the cover layer 972 is sufficiently thin to permit it to deflect by a selected amount in the event of an engagement force that exceeds a selected value, during engagement with a cam follower, such as the cam follower 66 (FIG. 2b). In an alternative embodiment (not shown) it is possible for the wall of the cover layer 972 to be divided into a plurality of segments which are all movable and which are adjacent on another. Some segments could be positioned to engage the thicker flexible member portions 973b, while other segments could be positioned to engage the thinner flexible member portions 973a.

Instead of controlling the relative flexibility of different regions by selecting the relative thicknesses of flexible material in those regions, the relative flexibility of different regions may be controlled by other means. For example, different regions could have different flexible materials.

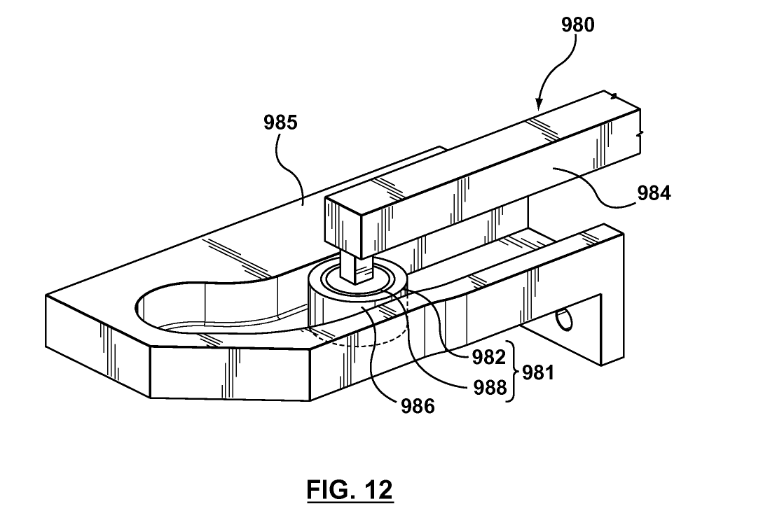

The cam follower 66 has been shown in FIG. 3a as having a roller portion that is rotatable. It is alternatively possible for the cam follower to be provided without a rotatable structure. For example, reference is made to FIG. 12, which shows such a cam follower, at 980. The cam follower 980 may include a cam engagement member 981 that is non-rotatably connected to and supported by a support structure 984. The cam engagement member 981 may be configured to slidingly engage the engagement surface of an inflexible cam, shown at 985. The cam engagement member 981 may have a cam engagement surface 986 that has any suitable shape to assist in the sliding engagement. For example, the surface 986 may be arcuate in the direction of travel of the engagement member 981. More particularly, the surface 986 may have an elliptical, circular or other arcuate shape. The cam follower 980 may include a flexible member 988 or compliance member 988 and a cover layer 982. The flexible member 988 is operatively connected to the entirety of the engagement surface 986 and thereby provides compliance thereto so that the engagement surface 986 moves to accommodate forces incurred during engagement with the cam 985.

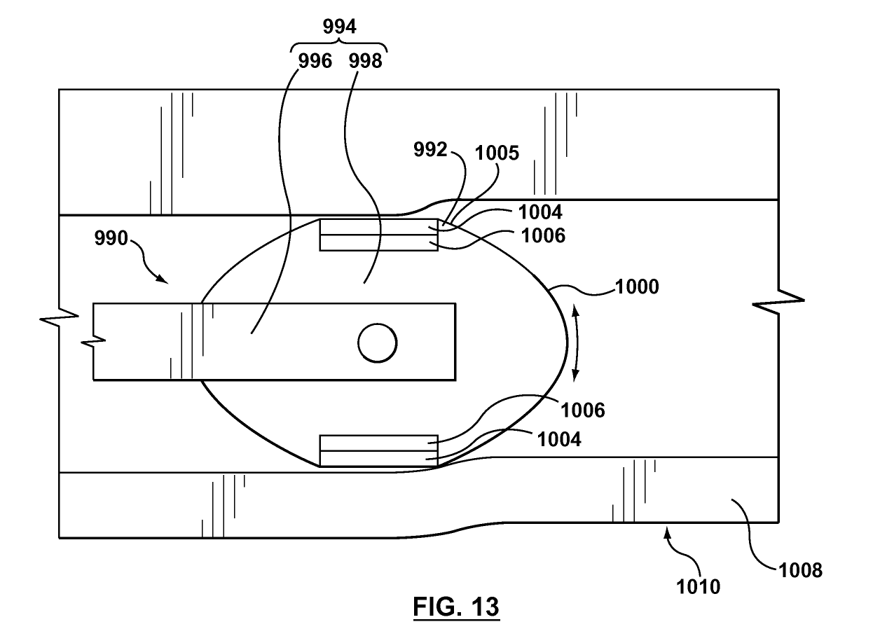

In an alternative embodiment shown in FIG. 13, there is provided a cam follower 990 which includes a rotatable member 1000, which is rotatably connected to a support arm 996.

The rotatable member 1000 may be shaped generally elliptically or may have some other suitable shape. The inner region of the rotatable member 1000 is shown at 998. The inner region 998 and the support arm 996 together make up a support structure 994.

The peripheral portion of the rotatable member 1000 is shown at 992 and makes up a cam engagement member which defines a cam engagement surface 1005. Along each side of the peripheral portion 992 is a flexible member 1006 or compliance member 1006 and a cover layer 1004. The cover layers 1004 are positioned to engage selected portions of a cam follower engagement member 1008 on a cam 1010. The selected portions of the cam follower engagement member 1008 may be, for example, the portions that represent a change in direction of the path defined by the cam 1010.

The outer surfaces of the cover layers 1004 make up portions of the cam engagement surface 1005. The flexible members 1006 are operatively connected to portions of the engagement surface 1005 and thereby provide compliance thereto to accommodate forces incurred between those portions and the cam 1010.

The flexible members 1006 may each be individually be provided with a selected flexibility. This can be achieved by any suitable means, such as by providing a selected thickness to each flexible member 1006, or for example, by making each flexible member 1006 out of an individually selected material.

During travel of the cam follower 990 along the path defined by the cam 1010, the rotatable member 1010 can rotate back and forth as necessary to fit along the path.

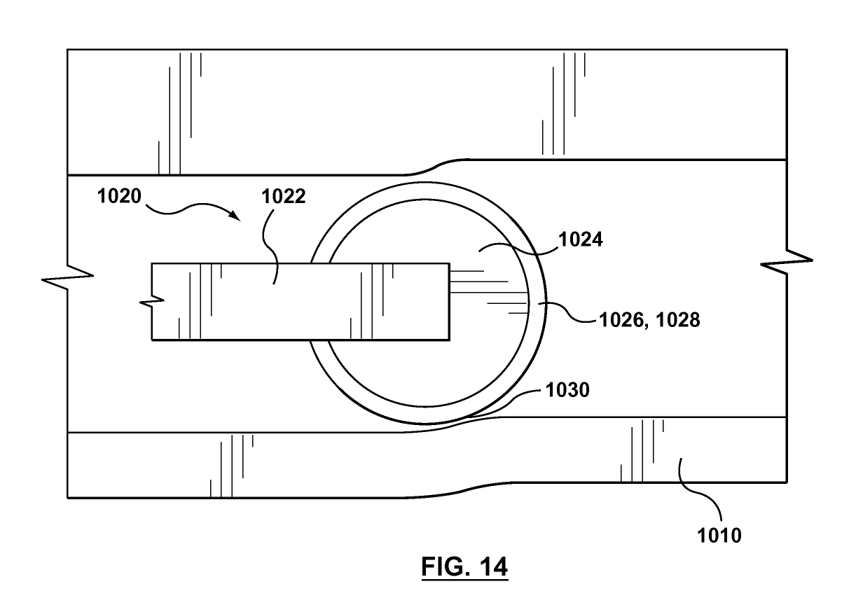

Reference is made to FIG. 14, which shows a cam follower 1020 in accordance with another embodiment of the present invention. The cam follower 1020 may include an arm 1022 fixedly connected to an arcuate member 1024, which has at its outer periphery a flexible member 1026 or compliance member 1026. The flexible member 1026 directly engages the cam 1010. The flexible member 1026 constitutes a cam engagement member 1028. The flexible member 1026 may be made from any suitable flexible material, such as polyurethane or rubber.

In the embodiment shown in FIG. 14, the arcuate member 1024 is round, however it may have any suitable shape. The arcuate member 1024 may be rotatably or non-rotatably connected to the arm 1022. The circumferential surface of the flexible member 1026 is a cam engagement surface 1030. The flexible members 1026 is thus operatively connected to the entirety of the cam engagement surface 1030 providing compliance thereto to accommodate forces incurred during engagement with the cam 1010.

In FIG. 1a, the first mold half 26 has been identified as the mold element 20 that is movable relative to the second mold half 28 so as to open and close the mold cavities 24, and the second mold half 28 has been identified as the mold element 20 that includes the gates into the mold cavities 24 and is stationary, at least in some machines, but is itself movable in some other machines, such as stack-mold machines. In an alternative embodiment that is not shown, it is possible for the first mold element to be the mold element that includes the gates into the mold cavities and which may be stationary and for the second mold element to be the mold element that is movable relative to the first mold element to open and close the mold cavities. In such an embodiment, the stripper assembly 22 could remain associated with the first mold element (ie. the mold element that has the gates into the mold cavities and which may be stationary). In such an embodiment, when the second mold element moves away from the first mold element to open the mold cavities, the molded articles would remain associated with the first mold element. The stripper assembly would then operate to remove the molded articles from the first mold element.

It should be appreciated that the number of the flexible stripping mold element cam systems used within a given implementation is not particularly limited and, as such, various configurations with at least one flexible stripping mold element cam system are envisioned. For example, in an alternative implementation of the FIG. 2B, it is envisioned that only one first mold split insert cam system 52 comprises a flexible stripping mold element cam system described above. Alternatively, in another alternative implementation of FIG. 2B, one of the first mold split insert cam systems 52 and one of the second mold split insert cam systems 58 may each comprise a respective flexible split mold insert cam system. Yet in other implementations, both of the first mold split insert cam systems 52 and both of the second mold split insert cam systems 58 may comprise a respective flexible mold split insert cam system. Yet further configurations are possible and within the scope of the embodiments of the present invention.

It has been described above that the first and second mold split inserts 30 and 32 move back and forth along an axis A2. It is not necessary that the two split inserts 30 and 32 move along the same axis. It is, for example, alternatively possible that they move along parallel axes.

The cams described herein have been shown to include a cam follower engagement surface that is a wall of a channel. It is alternatively possible for any of the cams to have a different configuration. For example, any of the cams could be configured to have a peripheral surface instead of a channel wall for engaging a cam follower.

It has been shown for the cam system to include a flexible member in one of the cam and the cam follower. It is alternatively possible for both the cam and cam follower to have a flexible member.

The flexible members described herein may be resilient in the sense that they generally return to a rest shape upon removal of external forces. It is alternatively possible, however, for any of the flexible members to incur some plastic, or permanent deformation during direct or indirect engagement with the cam follower. The flexible member may incur completely elastic deformation, some combination of elastic and plastic deformation, or completely plastic deformation. The flexible member may, for example, be made from a relatively soft, plastically deformable polymer. As another example, the flexible member may be made from a small sack of particulate material that is deformable under load, similar conceptually to a beanbag.

The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

1. A cam, comprising:
a support structure; and
a cam follower engagement member supported by the support structure, wherein the cam follower engagement member defines a cam follower engagement surface and includes a compliance member that is operatively connected to at least a portion of the cam follower engagement surface to accommodate a force on the cam follower engagement surface by a cam follower.

2. A cam as claimed in claim 1, wherein the compliance member is operatively connected to the entirety of the cam follower engagement surface.

3. A cam as claimed in claim 1, wherein the cam follower engagement member includes a plurality of compliance members, wherein each compliance member is operatively connected to a unique portion of the cam follower engagement surface.

4. A cam as claimed in claim 1, wherein the compliance member and the support structure are integrally connected together.

5. A cam as claimed in claim 1, wherein the compliance member defines a portion of the cam follower engagement surface.

6. A cam as claimed in claim 1, further comprising a cover layer that covers the compliance member.

7. A cam as claimed in claim 1, wherein the compliance member is made up of a layer of polymeric material.

8. A cam as claimed in claim 1, wherein the compliance member is made up of a layer of polyurethane.

9. A cam as claimed in claim 1, further comprising a cover layer that covers the compliance member, wherein the cover layer is connected to the compliance member and wherein the compliance member is connected to the support structure.

10. A cam as claimed in claim 1, wherein the cam follower engagement member further includes a movable element that is connected to the compliance member and wherein the movable element defines a portion of the cam follower engagement surface, wherein the movable element, the compliance member and the support structure are integrally connected together.

11. A cam as claimed in claim 1, wherein the cam follower engagement member defines a cam follower engagement channel configured to receive a cam follower.

12. A cam as claimed in claim 1, wherein the compliance member is operatively connected to the entirety of the cam follower engagement surface, wherein the cam follower engagement member defines a cam follower engagement channel configured to receive a cam follower, wherein the support structure defines a support structure channel configured to receive the compliance member.

13. A cam as claimed in claim 1, wherein the cam follower engagement member defines a path, wherein the compliance member is positioned along a portion of the path that changes direction.

14. A cam follower, comprising:
a support structure; and
a cam engagement member supported by the support structure, wherein the cam engagement member defines a cam engagement surface and includes a compliance member that is operatively connected to at least a portion of the cam engagement surface to accommodate a force on the cam engagement surface by a cam.

15. A cam follower as claimed in claim 14, wherein the compliance member is operatively connected to the entirety of the cam engagement surface.

16. A cam follower as claimed in claim 14, wherein the cam engagement member includes a plurality of compliance members, wherein each compliance member is operatively connected to a unique portion of the cam engagement surface.

17. A cam follower as claimed in claim 14, wherein the compliance member defines a portion of the cam engagement surface.

18. A cam follower as claimed in claim 14, further comprising a cover layer that covers the compliance member.

19. A cam follower as claimed in claim 14, wherein the compliance member is made up of a layer of polymeric material.

20. A cam follower as claimed in claim 14, wherein the compliance member is made up of a layer of polyurethane.

21. A cam follower as claimed in claim 14, further comprising a cover layer that covers the compliance member, wherein the cover layer is connected to the compliance member and wherein the compliance member is connected to the support structure.

22. A cam follower as claimed in claim 14, wherein the support structure includes a connecting portion and a rotary portion that is rotatable with respect to the connecting portion and wherein the compliance member is positioned radially between the rotary portion and the cam engagement surface.

23. A cam system, comprising:
a cam; and
a cam follower,
wherein at least one of the cam and cam follower includes a support structure and an engagement member supported by the support structure, wherein the engagement member defines an engagement surface and includes a compliance member that is operatively connected to at least a portion of the engagement surface to accommodate a force on the engagement surface by the other of the cam and cam follower.

24. A cam system as claimed in claim 23, wherein the compliance member is operatively connected to the entirety of the engagement surface.

25. A cam system as claimed in claim 23, wherein the engagement member includes a plurality of compliance members, wherein each compliance member is operatively connected to a unique portion of the engagement surface.

26. A cam system as claimed in claim 23, wherein the compliance member and the support structure are integrally connected together.

27. A cam system as claimed in claim 23, wherein the compliance member defines a portion of the engagement surface.

28. A cam system as claimed in claim 23, further comprising a cover layer that covers the compliance member.

29. A cam system as claimed in claim 23, wherein the compliance member is made up of a layer of polymeric material.

30. A cam system as claimed in claim 23, wherein the compliance member is made up of a layer of polyurethane.

31. A cam system as claimed in claim 23, further comprising a cover layer that covers the compliance member, wherein the cover layer is connected to the compliance member and wherein the compliance member is connected to the support structure.

32. A cam system as claimed in claim 23, wherein the engagement member further includes a movable element that is connected to the compliance member and wherein the movable element defines a portion of the engagement surface, wherein the movable element, the compliance member and the support structure are integrally connected together.

33. A cam system as claimed in claim 23, wherein the cam includes the engagement member and the support structure.

34. A cam system as claimed in claim 23, wherein the cam includes the engagement member and the support structure, wherein the engagement member defines a engagement channel configured to receive the cam follower.

35. A cam system as claimed in claim 23, wherein the cam includes the engagement member and the support structure, wherein the compliance member is operatively connected to the entirety of the engagement surface, wherein the engagement member defines a cam follower engagement channel configured to receive a cam follower, wherein the support structure defines a support structure channel configured to receive the compliance member.

36. A cam system as claimed in claim 23, wherein the cam includes the engagement member and the support structure, wherein the engagement member defines a path, wherein the compliance member is positioned along a portion of the path that changes direction.

37. A cam system as claimed in claim 23, wherein the cam follower includes the engagement member and the support structure.

38. A cam system as claimed in claim 23, wherein the cam follower includes the engagement member and the support structure, wherein the support structure includes a connecting portion and a rotary portion that is rotatable with respect to the connecting portion and wherein the compliance member is positioned radially between the rotary portion and the engagement surface.

39. A cam system as claimed in claim 23, wherein the cam follower includes the engagement member and the support structure, wherein the engagement member is movable relative to a path defined by the cam, wherein any portion of the engagement member that is engageable with the cam along a portion of the path that changes direction is a movable element.

40. A mold, comprising:
a plurality of mold elements including a first mold half, a second mold half, a first mold split insert and a second mold split insert, the plurality of mold elements together defining a mold cavity; and
a stripper assembly including a stripper plate that is associated with one of the first and second mold halves for relative movement therewith, and further including a cam and a cam follower, wherein the cam and cam follower are configured to cooperate with each other to generate relative movement between at least one of the first and second mold split inserts and the stripper plate,
wherein at least one of the cam and cam follower includes a support structure and an engagement member supported by the support structure, wherein the engagement member defines an engagement surface and includes a compliance member that is operatively connected to at least a portion of the engagement surface to accommodate a force on the engagement surface by the other of the cam and cam follower.

41. A mold as claimed in claim 40, wherein the compliance member is operatively connected to the entirety of the engagement surface.

42. A mold as claimed in claim 40, wherein the engagement member includes a plurality of compliance members, wherein each compliance member is operatively connected to a unique portion of the engagement surface.

43. A mold as claimed in claim 40, wherein the compliance member and the support structure are integrally connected together.

44. A mold as claimed in claim 40, wherein the compliance member defines a portion of the engagement surface.

45. A mold as claimed in claim 40, further comprising a cover layer that covers the compliance member.

46. A mold as claimed in claim 40, wherein the compliance member is made up of a layer of polymeric material.

47. A mold as claimed in claim 40, wherein the compliance member is made up of a layer of polyurethane.

48. A mold as claimed in claim 40, further comprising a cover layer that covers the compliance member, wherein the cover layer is connected to the compliance member and wherein the compliance member is connected to the support structure.

49. A mold as claimed in claim 40, wherein the engagement member further includes a movable element that is connected to the compliance member and wherein the movable element defines a portion of the engagement surface, wherein the movable element, the compliance member and the support structure are integrally connected together.

50. A mold as claimed in claim 40, wherein the cam includes the engagement member and the support structure.

51. A mold as claimed in claim 40, wherein the cam includes the engagement member and the support structure, wherein the engagement member defines a engagement channel configured to receive the cam follower.

52. A mold as claimed in claim 40, wherein the cam includes the engagement member and the support structure, wherein the compliance member is operatively connected to the entirety of the engagement surface, wherein the engagement member defines a cam follower engagement channel configured to receive a cam follower, wherein the support structure defines a support structure channel configured to receive the compliance member.

53. A mold as claimed in claim 40, wherein the cam includes the engagement member and the support structure, wherein the engagement member defines a path, wherein the compliance member is positioned along a portion of the path that changes direction.

54. A mold as claimed in claim 40, wherein the cam follower includes the engagement member and the support structure.

55. A mold as claimed in claim 40, wherein the cam follower includes the engagement member and the support structure, wherein the support structure includes a connecting portion and a rotary portion that is rotatable with respect to the connecting portion and wherein the compliance member is positioned radially between the rotary portion and the engagement surface.

56. A mold as claimed in claim 40, wherein the cam follower includes the engagement member and the support structure, wherein the engagement member is movable relative to a path defined by the cam, wherein any portion of the engagement member that is engageable with the cam along a portion of the path that changes direction is a movable element.

57. A mold as claimed in claim 40, wherein the stripper assembly further includes a pair of the cam and cam follower to generate the relative movement between the at least one of the first and second mold split inserts and the stripper plate.

58. A mold as claimed in claim 40, wherein the mold further includes a second cam and a second cam follower, wherein the second cam and the second cam follower are configured to cooperate with each other to generate the relative movement between the at least one of the first and second mold split inserts and the stripper plate.

59. A molding system, comprising:
a molding machine;
a plurality of mold elements including a first mold half, a second mold half, a first mold split insert and a second mold split insert, the plurality of mold elements together defining a mold cavity; and
a stripper assembly including a stripper plate that is associated with one of the first and second mold halves for relative movement therewith, and further including a cam and a cam follower, wherein the cam and cam follower are configured to cooperate with each other to generate relative movement between at least one of the first and second mold split inserts and the stripper plate,
wherein at least one of the cam and cam follower includes a support structure and an engagement member supported by the support structure, wherein the engagement member defines an engagement surface and includes a compliance member that is operatively connected to at least a portion of the engagement surface to accommodate a force on the engagement surface by the other of the cam and cam follower.

60. A molding system as claimed in claim 59, wherein the compliance member is operatively connected to the entirety of the engagement surface.

61. A molding system as claimed in claim 59, wherein the engagement member includes a plurality of compliance members, wherein each compliance member is operatively connected to a unique portion of the engagement surface.

62. A molding system as claimed in claim 59, wherein the compliance member and the support structure are integrally connected together.

63. A molding system as claimed in claim 59, wherein the compliance member defines a portion of the engagement surface.

64. A molding system as claimed in claim 59, further comprising a cover layer that covers the compliance member.

65. A molding system as claimed in claim 59, wherein the compliance member is made up of a layer of polymeric material.

66. A molding system as claimed in claim 59, wherein the compliance member is made up of a layer of polyurethane.

67. A molding system as claimed in claim 59, further comprising a cover layer that covers the compliance member, wherein the cover layer is connected to the compliance member and wherein the compliance member is connected to the support structure.

68. A molding system as claimed in claim 59, wherein the engagement member further includes a movable element that is connected to the compliance member and wherein the movable element defines a portion of the engagement surface, wherein the movable element, the compliance member and the support structure are integrally connected together.

69. A molding system as claimed in claim 59, wherein the cam includes the engagement member and the support structure.

70. A molding system as claimed in claim 59, wherein the cam includes the engagement member and the support structure, wherein the engagement member defines a engagement channel configured to receive the cam follower.

71. A molding system as claimed in claim 59, wherein the cam includes the engagement member and the support structure, wherein the compliance member is operatively connected to the entirety of the engagement surface, wherein the engagement member defines a cam follower engagement channel configured to receive a cam follower, wherein the support structure defines a support structure channel configured to receive the compliance member.

72. A molding system as claimed in claim 59, wherein the cam includes the engagement member and the support structure, wherein the engagement member defines a path, wherein the compliance member is positioned along a portion of the path that changes direction.

73. A molding system as claimed in claim 59, wherein the cam follower includes the engagement member and the support structure.

74. A molding system as claimed in claim 59, wherein the cam follower includes the engagement member and the support structure, wherein the support structure includes a connecting portion and a rotary portion that is rotatable with respect to the connecting portion and wherein the compliance member is positioned radially between the rotary portion and the engagement surface.

75. A molding system as claimed in claim 59, wherein the cam follower includes the engagement member and the support structure, wherein the engagement member is movable relative to a path defined by the cam, wherein any portion of the engagement member that is engageable with the cam along a portion of the path that changes direction is a movable element.

76. A molding system as claimed in claim 59, wherein the stripper assembly further includes a pair of the cam and cam follower to generate the relative movement between the at least one of the first and second mold split inserts and the stripper plate.

77. A molding system as claimed in claim 59, wherein the mold further includes a second cam and a second cam follower, wherein the second cam and the second cam follower are configured to cooperate with each other to generate the relative movement between the at least one of the first and second mold split inserts and the stripper plate.
